(19) United States
(12) Patent Application Publication
(10) Pub. No.: US 2025/0041966 A1
(43) Pub. Date: Feb. 6, 2025

(54) LASER PROCESSING HEAD AND METHOD FOR PROCESSING A WORKPIECE

(71) Applicant: TRUMPF Werkzeugmaschinen SE + Co. KG, Ditzingen (DE)

(72) Inventors: Wolfgang Andreasch, Weinstadt (DE); Maximilian Merk, Renningen (DE); Martin Johannes Geiger, Günzburg (DE)

(21) Appl. No.: 18/922,471

(22) Filed: Oct. 22, 2024

Related U.S. Application Data
(63) Continuation of application No. PCT/EP2023/059894, filed on Apr. 17, 2023.

(30) Foreign Application Priority Data
Apr. 25, 2022 (DE) 10 2022 109 848.6

(51) Int. Cl. B23K 26/064; B23K 26/38

(52) U.S. Cl. CPC B23K 26/064; B23K 26/38

(57) ABSTRACT

A laser processing head for processing a workpiece by a laser beam includes at least one scanning device for diverting the laser beam, and at least one collimator for collimating the laser beam. The at least one collimator is movable during operation along a propagation direction of the laser beam, whereby a diameter of the laser beam incident on the workpiece is changeable.

### CROSS REFERENCE TO RELATED APPLICATIONS

This application is a continuation of International Application No. PCT/EP2023/059894 (WO 2023/208625 A1), filed on Apr. 17, 2023, and claims benefit to German Patent Application No. DE 10 2022 109 848.6, filed on Apr. 25, 2022. The aforementioned applications are hereby incorporated by reference herein.

### FIELD

Embodiments of the present invention relate to a laser processing head and a method for processing a workpiece.

### BACKGROUND

In the technical field of laser processing of workpieces, laser processing machines with controlled laser processing heads are common. The laser processing machines comprise a laser source for providing laser power, in particular for cutting or welding workpieces. The laser processing head usually comprises various components and optics with which a controlled laser beam is specifically fed to processing positions on the workpiece. Controlled diversion optics in the laser processing head are known, which can be rapidly tilted or pivoted and redirect the processing laser beam in two vertical axes so that any two-dimensional cutting geometries or welding geometries can be achieved on the workpiece. Also known are sensor devices on the laser processing head, which record the machined geometries on the workpiece for quality control and other functions, such as controlling the processing procedure.

### SUMMARY

Embodiments of the present invention provide a laser processing head for processing a workpiece by a laser beam. The laser processing head includes at least one scanning device for diverting the laser beam, and at least one collimator for collimating the laser beam. The at least one collimator is movable during operation along a propagation direction of the laser beam, whereby a diameter of the laser beam incident on the workpiece is changeable.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic perspective view of a laser processing head with a scanning device, a laser source connected via a laser light cable, and a control device according to an embodiment of the invention;

FIG. 2 shows a schematic side view of a laser processing head with a path of a laser beam to a workpiece according to an embodiment of the invention; and

FIG. 3 shows various plan views of geometries of spots of a laser beam, which are implemented with a laser processing head according to an embodiment of the invention.

### DETAILED DESCRIPTION

Embodiments of the invention provide a laser processing head and a method for processing a workpiece, with which a variety of processing options for workpieces are achieved.

A laser processing head is provided for processing a workpiece by means of a laser beam, comprising at least one scanning device for diverting the laser beam and at least one collimator for collimating the laser beam, wherein the at least one collimator can be moved during operation along the propagation direction of the laser beam, whereby a diameter D of the laser beam incident on the workpiece can be changed.

Furthermore, a method for processing a workpiece by means of a laser beam is provided, having the method steps:
Providing a laser processing head comprising at least one scanning device for diverting the laser beam and at least one collimator for collimating the laser beam;
Changing a diameter D of the laser beam incident on the workpiece by moving the collimator during operation along the propagation direction of the laser beam.

In this case, preferably at a starting point of a processing procedure, a spot diameter can be reduced from an initial diameter to an intended processing diameter. Alternatively or simultaneously, a power of the laser beam can be increased from an initial power to a processing power intended for processing the workpiece. Furthermore, it is conceivable that at an end point of a processing procedure the spot diameter is increased from the processing diameter intended for processing the workpiece to a predetermined extension diameter. Alternatively or simultaneously, the power of the laser beam intended for processing the workpiece can be reduced from the processing power to an intended extension power.

In one embodiment of the invention, the at least one scanning device comprises a first scanner mirror for scanning the laser beam in a first direction on the workpiece and a second scanner mirror for scanning the laser beam in a second direction on the workpiece. The phrase scanning by means of the scanning device here means the controlled and targeted diversion or redirection of the laser beam from the incoming laser beam path. The scanning device is understood here to mean in particular any apparatus that is designed to deflect the laser beam in a controlled manner. The processing laser beam can thus be applied to any variable position on the workpiece.

In one embodiment, the collimator comprises a convex lens system or a convex lens. Lens systems are easy to construct and at the same time are able to shape the laser beam effectively. The convex lens system comprises at least one convex lens and optionally also other optical lenses.

In a further embodiment of the invention, the laser processing head comprises at least one deflection mirror in the propagation direction of the laser beam behind the scanning device, at least one lens for focusing the laser beam onto the workpiece and a sensor system for detecting radiation from the workpiece being processed. The deflection mirror deflects the laser beam redirected by the scanning device in the laser processing head in the direction of the workpiece, approximately in a vertical direction. The lens focuses the laser beam from the deflection mirror in a suitable manner onto the workpiece, preferably into a focal plane which lies on the workpiece in a processing position. The sensor system detects the radiation, process radiation that is generated when the workpiece is processed, or other radiation and provides data regarding the processing procedure on the workpiece, such as the welding depth, the position of the weld or the seam geometry. The sensor system is advantageously used to monitor the laser processing by the laser processing head, and the sensor system further provides data for controlling and regulating the laser processing. The sensor system can include a camera and/or an interferometer. The camera preferably captures the process radiation or process light that is created when the laser beam interacts with the material of the workpiece. The interferometer preferentially detects radiation that is emitted by the interferometer itself and reflected from the workpiece. For the purpose of directing radiation to the sensor system, a beam splitter is provided which allows the radiation of the laser beam to pass through to the workpiece and diverts the radiation from the workpiece to the sensor system.

In another embodiment of the invention, the laser processing head has a rotatable process nozzle which supplies a process medium for adapting the process nozzle to a direction of movement of the laser beam along the workpiece.

In another embodiment, a laser source delivers variable laser power to the laser processing head via a laser light cable. The laser source usually generates the laser beam, which is guided through the laser light cable to the laser processing head. In this embodiment, the laser power at the laser source is changed in a controlled manner so that the laser beam has different intensities, and the workpiece is exposed to correspondingly different energies which influence the processing result. In addition, the beam movement of the laser beam in combination with the diameter D controlled by the movable collimator allows the intensity distribution of the laser radiation to be specifically adjusted on the workpiece.

Further advantages of the invention are evident from the description and the figures. The embodiments shown and described should not be understood as an exhaustive enumeration, but rather are of an exemplary character for describing the invention.

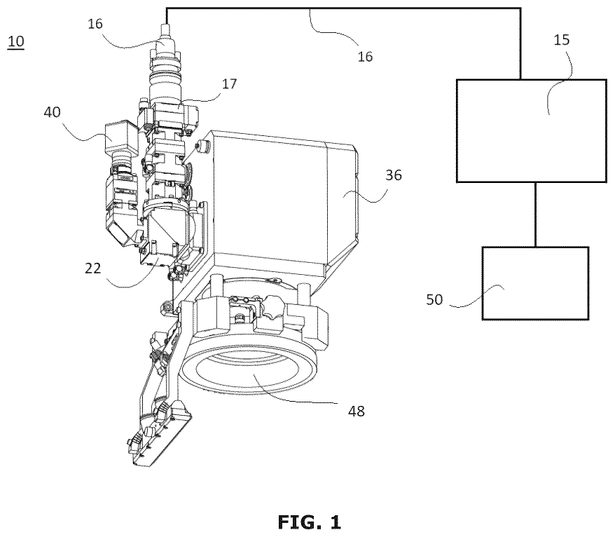

FIG. 1 shows a schematic perspective external view of a laser processing head 10 according to an embodiment of the invention. The laser processing head 10 is an essential component of a laser processing machine, and is controlled by robots. The laser processing head 10 comprises a coupler 17, which is connected to an optical fiber cable 16 for coupling laser power from a laser source 15 into the laser processing head 10. The laser source 15 can be designed in different ways, for example as a solid-state laser source, and generates a laser beam 12. The laser processing head 10 and the laser source 15 are connected with regard to signaling to at least one control device 50. Furthermore, the laser processing head 10 comprises a scanning device 22, which comprises various optics for two-dimensionally diverting the laser beam 12 in the laser processing head 10, i.e., for simultaneously controlled diversion of the laser beam in two spatial directions. This two-dimensional diversion or redirection of the laser beam 12 is called wobbling. The laser processing head 10 further comprises a housing 36 connected to the scanning device 22, in which are mounted further optical elements. The scanning device 22 can also be integrated into the housing 36. The laser beam 12 is guided into the housing 36 of the laser processing head 10 and redirected to an exit opening 48. During operation, the laser beam 12 leaves the laser processing head 10 at the exit opening 48. In this example, the laser processing head 10 comprises a sensor system 40 which is connected to the scanning device 22. The sensor system 40 comprises a camera and/or an interferometer for detecting signals from a workpiece 14 to be machined. The camera detects process radiation from the workpiece 14, which is fed to the camera through the laser processing head 10. The camera has a narrow-band illumination for wavelength-selective recording, which is thus independent of the process radiation or process lights because it can be easily filtered, as well as for recording images on the workpiece 14, which are evaluated via subsequent image processing in the control device 50. The interferometer, which is alternatively or additionally included in the sensor system 40, typically transmits a low power laser beam through the laser processing head 10, which is reflected off the workpiece 14, reflected back to the interferometer by the laser processing head 10, and interferes with a reference beam. In particular, the low-power laser beam can be aligned to be coaxial to the laser beam 12 from the laser source 15. As an alternative to the interferometer, the sensor system 40 can comprise a line laser. With the line laser, the distance between the laser processing head 10 and the workpiece 14 is determined together with the camera according to the triangulation principle. In all three cases, data relating to the processing procedure is determined, transmitted to the control device 50, and further processed. This data includes data on the weld seam, the welding depth, and/or the welding geometry.

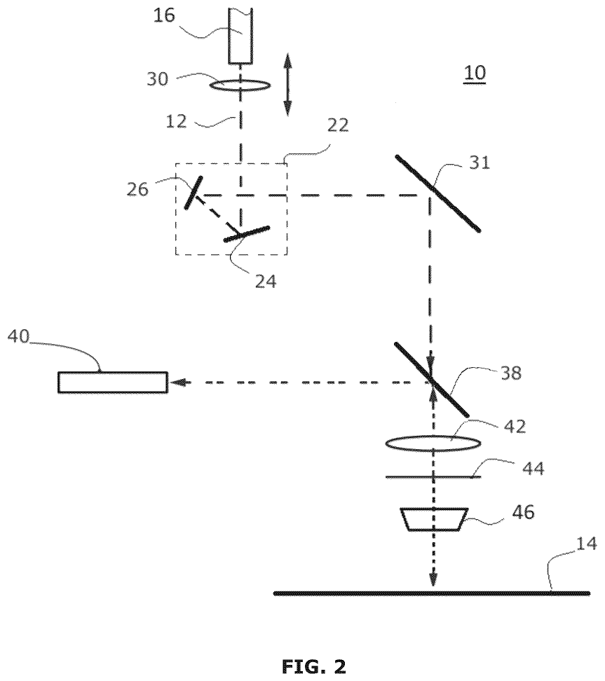

FIG. 2 shows a schematic side view of components of the laser processing head 10 to further explain the functionality. The divergent laser beam 12 shown in dashed lines leaves the optical fiber cable 16 shown in section to a collimator 30 which is arranged in the laser processing head 10. The coupler 17 for connecting and coupling the laser beam 12 is not shown in FIG. 2. The collimator 30 in this example is a convex lens which provides an almost parallel beam path of the laser beam 12 at the exit of the lens, below the collimator 30 in FIG. 2, in the direction of the path of the laser beam 12; the beam path or the propagation of the laser beam 12 is changed from divergent to parallel to convergent. The collimator 30 can comprise further lenses, such as a convex lens system consisting of several convex lenses. After the collimator 30, the laser beam 12 is fed to the scanning device 22, which is schematically shown in FIG. 2 as a dashed rectangle. The scanning device 22 comprises a first scanner mirror 24 and a second scanner mirror 26, from which the laser beam 12 is reflected one after the other. The first scanner mirror 24 and the second scanner mirror 26 are controlled by the control device 50, wherein the first scanner mirror 24 redirects the laser beam 12 in a first axis and the second scanner mirror 26 simultaneously redirects the laser beam 2 in a second axis perpendicular to the first axis. Consequently, the laser beam 12 is redirected by the scanning device 22 in two spatial dimensions. The first scanner mirror 24 and the second scanner mirror 26 are typically driven by fast galvanometer scanners with motors from the controller 50. The scanning device 22 can also be referred to as a 2D scanner. After the scanning device 22, the laser beam 12 strikes a deflection mirror 31 in the laser processing head 10, which deflects the laser beam 12 in the direction of a beam splitter 38, in this case in a vertical direction. The deflection mirror 31 is installed immovably in the laser processing head 10. The laser beam 12 incident on the beam splitter 38 from above in FIG. 2 passes through the beam splitter 38 essentially unhindered and is guided to an objective 42 which focuses the laser beam 12 onto the workpiece 14. The focal plane of the laser beam 12 is adjusted by means of the lens 42 approximately to the distance between a process nozzle 46 and the workpiece 14. Behind the lens 42 of the laser processing head 10, viewed in the direction of the laser beam 12, a protective glass 44 is arranged which protects the optics of the laser processing head 10 from external influences and erosion of the workpiece 14. The laser beam 12 leaves the laser processing head 10 at the exit opening 48 and strikes the workpiece 14 to be processed. The process nozzle 46 is arranged to be rotatable, wherein the angle of rotation of the process nozzle 46 is controlled by the control device 50 such that the orientation of the process nozzle 46 corresponds to the impact positions of the laser beam 12 on the workpiece 14. The rotation of the process nozzle 46 consequently causes the process medium to be incident on the workpiece 14 at the same positions to which the laser beam 12 is directed. The laser beam 12 is shifted in the direction of its path along the workpiece 14 by an angle a according to the controlled redirection of the first scanner mirror 24 and the second scanner mirror 26. During operation, there is usually a relative movement between the laser processing head 10 and the workpiece 14. The controlled pivoting of the first scanner mirror 24 and the second scanner mirror 26 by approximately an angle a results in the processing positions being shifted accordingly by an angle a during the relative movement, and a weld seam then runs offset by the angle a without pivoting. The control device 50 can specify any angle of rotation for the scanning device 22 and can thus orient the laser beam 12 as desired on the workpiece 14.

Due to the described controlled diversion of the laser beam 12 in the scanning device 22, the laser beam can cover any two-dimensional geometries or shapes on the workpiece 14, for example, can create curved weld seams. A process medium, such as process gas, is thus supplied in a targeted manner using the controlled rotatable process nozzle 46, which follows the laser beam 12 deflected in the scanning device 22.

The sensor system 40, which comprises at least one camera, detects radiation from the machined workpiece 14, which is created as an interaction of the laser beam 12 striking the material of the workpiece 14. Alternatively, the sensor system 40 comprises an interferometer which receives the low power laser beam emitted by the interferometer and reflected by the workpiece 14. In both cases, the radiation runs from the workpiece 14 in the direction of the beam splitter 38, through which the radiation is transmitted and reflected in the direction of the sensor system 40, at approximately a right angle in FIG. 2. Alternatively, the sensor system 40 is arranged at the deflection mirror 31, whereby the beam splitter 38 becomes obsolete. In this alternative, the reflected radiation or the process radiation from the workpiece 14 takes the same path as the laser beam 12 without beam splitting. The reflected radiation or the process radiation from the workpiece 14 is shown in FIG. 2 with dashed lines on an arrow directed towards the beam splitter 38 and on an arrow directed towards the sensor system 40. The sensor system 40 is connected with regard to signaling to the control device 50 and receives and processes the data of the sensor system 40.

The collimator 30 near the entrance of the laser processing head 10 behind the optical fiber cable 16 can be moved along the propagation direction of the laser beam 12, in FIG. 2 in the vertical direction up and down. The control device 50 sends signals to a drive, to a motor, to the collimator 30, which moves the collimator 30 accordingly. Due to the change in the position of the collimator 30, the beam path of the laser beam 12 incident on the collimator 30 is changed in such a way that a diameter D of the laser beam 12 incident on the workpiece 14 is changed. The diameter D of the laser beam 12 on the workpiece 14 is adjusted accordingly. In addition to the expansion of the interaction area, this also controls the energy input of the laser beam 12 into the workpiece 14.

The described combination of changing the diameter D of the laser beam 12, the beam diameter, at the surface of the workpiece 14 with the two-dimensional alignment of the laser beam 12 by the scanning device 22 enables more flexible applications of the laser processing head 10 with regard to the geometries and the course of weld seams and higher-frequency laser processing.

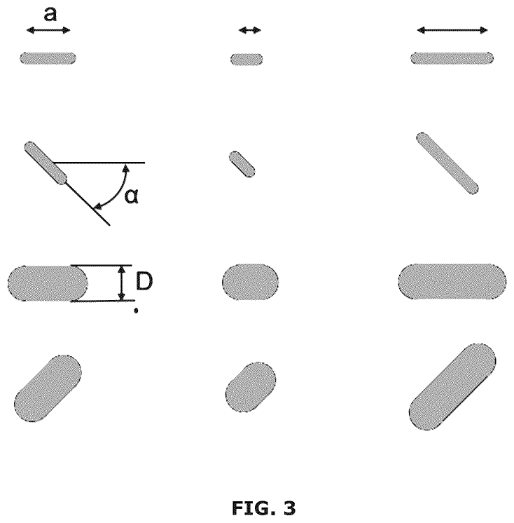

FIG. 3 shows various plan views of geometries of spots or tracks of the laser beam 12 on the workpiece 14, which are implemented with a laser processing head 10 according to an embodiment of the invention. A spot is defined as an area of a laser beam 12 incident on the workpiece 14 at one moment. A sequence of currently recorded spots results in a seam course during a welding process. In the upper row of FIG. 3, three different spot geometries are shown, which are caused solely by changing the laser power at the laser source 15 by the control device 50. The higher the laser power or the amplitude of the laser power is set, the larger the extension a of the geometry, with the extension a being largest on the right side of the top row in FIG. 3. The processing direction through the laser processing head 10, the relative movement of the laser processing head 10 to the workpiece 14, is perpendicular to the extension a, i.e., the extension a describes the width of the resulting weld seam at different laser powers. In the second row of FIG. 3, three examples of a changed orientation of the laser beam 12 are shown. The extension a of the geometry is unchanged from the upper row, so that the extensions a in FIG. 3 correspond column by column with the smallest extension a of the laser power in the middle. The scanning device 22 has redirected the laser beam 12 by the same angle a for all three geometries in the second row, so that the alignment or orientation of the laser beam 12 on the workpiece 14 is changed by the angle a compared to the un-redirected scanning device 22. In the third row according to FIG. 3, the orientation of the geometry of the spots or tracks is as in the first row without rotation by the first scanner mirror 24 and the second scanner mirror 26 of the scanning device 22, and the same extension a corresponding to an amplitude of a laser power at the laser source 15 as in the upper two rows according to FIG. 3. In the three geometries in the third and fourth rows, the collimator 30 is moved or displaced in a controlled manner compared to the two upper rows, with the effect that the diameter D of the spots is increased. The diameter D is defined here as the length in the feed direction of the workpiece 14 perpendicular to the extension a. In the third row, three identical diameters D are shown corresponding to a position of the scanning device 22 with three different extensions a corresponding to three different laser powers. In the fourth row, the same diameters D and the same dimensions a of the geometries are shown as in the third row, wherein the orientation of the geometries is changed compared to the geometries of the third row according to a controlled alignment of the laser beam 12 by the scanning device 22. FIG. 3 shows exemplary geometries which are achieved by combining the features of the laser processing head 10. The geometries according to FIG. 3 refer to individual spots and are continued as desired along welding paths, whereby during operation the extent a and the diameter D of the spot as well as the orientation with the angle a can be changed independently of one another individually or together according to programmed instructions in the control device 50.

The laser processing head 10 and the method for processing the workpiece 14 enable switching from deep welding to heat conduction welding and vice versa during operation by changing the laser power at the laser source 15 and/or by changing the diameter D of the spot of the laser beam 12 on the workpiece 14 by moving the collimator 30. The control device 50 can dynamically adjust the spot of the laser beam 12 with oscillating movements of the spot at an adjustable frequency on the scanning device 22, which indicates the swivel frequency of the first scanning mirror 24 and the second scanning mirror 26. The design of the seam course of the welding path is selected in the control device 50 by the operator of a laser processing machine; the seam course of the welding seam can, for example, be circular, loop-shaped, C-shaped, or triangular.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Symbols

10 Laser processing head
12 Laser beam
14 Workpiece
15 Laser source
16 Optical fiber cable
17 Coupler
22 Scanning device
24 First scanner mirror
26 Second scanner mirror
30 Collimator
31 Deflection mirror
36 Housing
38 Beam splitter
40 Sensor system
42 Lens
44 Protective glass
46 Process nozzle
48 Outlet opening
50 Control device

1. A laser processing head for processing a workpiece by a laser beam, the laser processing head comprising: at least one scanning device for diverting the laser beam, and at least one collimator for collimating the laser beam, wherein the at least one collimator is movable during operation along a propagation direction of the laser beam, whereby a diameter of the laser beam incident on the workpiece is changeable.

2. The laser processing head according to claim 1, further comprising a controlled or regulated actuator configured to move the collimator.

3. The laser processing head according to claim 1, wherein the at least one scanning device comprises a first scanner mirror for scanning the laser beam in a first direction on the workpiece, and a second scanner mirror for scanning the laser beam in a second direction on the workpiece.

4. The laser processing head according to claim 1, wherein the at least one collimator comprises a convex lens system or a convex lens.

5. The laser processing head according to claim 1, further comprising a deflection mirror in the propagation direction of the laser beam downstream from the scanning device, at least one objective for focusing the laser beam on the workpiece, and a sensor for detecting radiation from the workpiece.

6. The laser processing head according to claim 5, further comprising a beam splitter downstream from the scanning device for passing the laser beam to the workpiece and for reflecting the radiation from the workpiece to the sensor.

7. The laser processing head according to claim 5, wherein the sensor comprises a camera and/or an interferometer.

8. The laser processing head according to claim 1, further comprising a rotatable process nozzle for supplying a process medium, wherein the process nozzle is configured to be aligned with a direction of movement of the laser beam along the workpiece.

9. The laser processing head according to claim 1, wherein the laser beam is provided by a laser source with a variable laser power via an optical fiber cable.

10. A method for processing a workpiece by a laser beam, the method comprising:
providing a laser processing head comprising at least one scanning device for diverting the laser beam, and at least one collimator for collimating the laser beam; and
changing a diameter of the laser beam incident on the workpiece by moving the collimator during operation along a propagation direction of the laser beam.

11. The method according to claim 10, further comprising:
providing a first scanner mirror and a second scanner mirror in the scanning device; and
scanning the laser beam relative to the workpiece with the first scanner mirror in a first direction and with the second scanner mirror in a second direction.

12. The method according to claim 10, further comprising:
providing a sensor on the laser processing head; and
detecting radiation from the workpiece by the sensor.

13. The method according to claim 10, further comprising:
providing a rotatable process nozzle on the laser processing head; and
supplying a process medium through the process nozzle, and rotating the process nozzle to align the process nozzle with a direction of movement of the laser beam along the workpiece.

14. The method according to claim 10, further comprising:
providing a laser source for generating the laser beam to be coupled to the laser processing head via an optical fiber cable; and
providing a variable laser power at the laser source for the laser processing head.

15. A laser processing machine comprising a laser source with an optical fiber cable for supplying a laser beam to a laser processing head according to claim 1.
